(19) United States
(12) Patent Application Publication
(10) Pub. No.: US 2012/0025665 A1
(43) Pub. Date: Feb. 2, 2012

(54) SINGLE-PHASE BRUSHLESS MOTOR

(75) Inventors: Yuuki TAKAHASHI, Kitasaku-gun (JP); Yuzuru SUZUKI, Kitasaku-gun (JP)

(73) Assignee: MINEBEA CO., LTD., Kitasaku-gun (JP)

(21) Appl. No.: 13/184,148

(22) Filed: Jul. 15, 2011

(30) Foreign Application Priority Data
Jul. 27, 2010 (JP) 2010-167950

(51) Int. Cl. H02K 1/14

(52) U.S. Cl. 310/216.094

(57) ABSTRACT

A single-phase brushless motor, includes: a rotor including plural magnetic poles; a stator disposed facing the rotor via a gap and including the same number of salient poles as that of the magnetic poles; a driving coil wound around the plural salient poles; a salient pole surface having a bevel-shape and provided on each salient pole, the salient pole surface facing the rotor a groove provided at a position between a center and an end in a circumferential direction of each salient pole surface; in which a wave shape of each surface magnetic flux of the plural magnetic poles has a distribution of the surface magnetic flux density composed of sloping portions disposed at both sides of the wave shape and a plane portion disposed between the sloping portions.

### BACKGROUND OF THE INVENTION

1. Field of the Invention

The present invention relates to a single-phase brushless motor that has stable start-up and has reduced cogging torque characteristics.

2. Related Art

Cogging torque causes vibration and noise in motors, and cogging torque should therefore preferably be minimized. As a technique for a single-phase motor relating to start-up stability and reduced cogging torque characteristics, a technique disclosed in Japanese Patent Application, First Publication No. 2002-359995 is known. This gazette publication discloses a structure provided with a starting coil in which a rotor stopping at a dead point can be reliably started up and is rotated and held at a position except for the dead point in starting up a motor in order to inhibit occurrence of cogging torque.

Furthermore, Japanese Utility Model Application, Publication No. 6-66281 discloses a technique in which rotational unevenness can be inhibited by a structure in which even number teeth at a stator side are provided with a flange and a groove recessed in a radial outward direction is formed at a middle portion in a circumferential direction of the flanges. Japanese Patent Application, First Publication No. 7-227073 discloses a structure in which high start-up reliability can be obtained by a device of an electrifying method instead of a structural device.

### SUMMARY OF THE INVENTION

In a technique disclosed in Japanese Patent Application, First Publication No. 2002-359995, the starting coil for stabilizing the start-up is not effective for the torque, and therefore the starting coil is not efficient. In the techniques disclosed in Japanese Utility Model Application, Publication No. 6-66281 and Japanese Patent Application, First Publication No. 7-22073, start-up instability is increased when the techniques are applied to single-phase brushless motors.

Cycle length of the cogging torque is the order of the least common multiple of number of slots of a motor and number of magnetic poles of a magnet and the peak value of the cogging torque is reduced according to increase of the order. Therefore, the cogging torque of the single-phase brushless motor is reduced as number of the magnetic poles is increased. However, when facilitation of winding a wire is considered in mass-production, an air gap between salient poles prepared for winding the wire is limited, so that circumferential dimension of the air gap between the salient poles is increased according to the increase in the number of magnetic poles. The air gap generates reluctance, thereby causing cogging torque. Therefore, the advantage in the increase in the number of the magnetic poles is balanced out and effect thereof is limited, so that performance of the motor is usually the same as that of a typical motor provided with four poles and four slots. This is one of reasons why a compact single-phase motor is provided with four poles and four slots.

Under these circumstances, an object of the present invention is to provided a technique in which cogging torque can be greatly reduced while maintaining start-up stability as a single-phase motor.

According to a first aspect of the present invention, a single-phase brushless motor includes a rotor including plural magnetic poles; a stator disposed facing the rotor via a gap and including the same number of salient poles as that of the magnetic poles; a driving coil wound around the plural salient poles; a salient pole surface having a bevel-shape and provided on each salient pole, the salient pole surface facing the rotor; a groove provided at a position between a center and an end in a circumferential direction of each salient pole surface; in which a wave shape of each surface magnetic flux of the plural magnetic poles has a distribution of the surface magnetic flux density composed of sloping portions disposed at both sides of the wave shape and a plane portion disposed between the sloping portions.

According to the first aspect of the present invention, balancing torque with respect to cogging torque is generated by providing the groove at the position between the center and the end of the salient pole surface, so that the peak value of the cogging torque can be reduced. Furthermore, decrease in a back-electromotive force is small compared to the case in which the groove is not provided, so that start-up stability can be obtained.

According to a second aspect of the present invention, in accordance with the first aspect, the groove is formed at both sides of the center of the each salient pole surface in the circumferential direction. By the effect of forming the groove at the position between the center and the end of salient pole surface in the first aspect, one of peak values in a positive side and a negative side of the cogging torque can be reduced. According to the second aspect, one peak value in the positive side or the negative side of the cogging torque can be reduced by the function of the groove provided at one side of the center on the salient pole surface and another peak value in the positive side or the negative side of the cogging torque can be reduced by the function of the groove provided at another side thereof. Therefore, both peak values in the positive side and the negative side of the cogging torque can be reduced.

According to a third aspect of the present invention, in accordance with the first aspect or the second aspect, an angular width between a center position of the adjacent salient poles in the circumferential direction and an end of the groove in a direction toward an end portion of the salient pole surface around the rotational center is defined as θA, an angular width between the ends the adjacent salient pole in the circumferential direction around the rotational center is defined as 2θY and an angular width between both ends of the sloping portion of the wave shape of the magnetic pole of the rotor around the rotational center is defined as θZ, and a formula θA≧θY+θZ is satisfied.

According to a fourth aspect of the present invention, in accordance with one of the first to third aspects, one of a positive peak value and a negative peak value of a cogging torque occurring in a case not provided with the groove can be reduced by providing the groove at the position between the center and the end of the salient pole surface in the circumferential direction.

According to a fifth aspect of the present invention, in accordance with one of the first to fourth aspects, an outer-rotor-type structure or an inner-rotor-type structure is applied.

According to the first aspect of the present invention, the cogging torque can be greatly reduced maintaining start-up stability in a single-phase motor.

According to the second aspect of the present invention, the peak values at the positive side and the negative side of the cogging torque can be reduced.

According to the third aspect of the present invention, the position of the groove for an effective reduction of the cogging torque can be limited.

According to the fourth aspect of the present invention, a pinpoint reduction of the peak value of the cogging torque can be realized.

According to the fifth aspect of the present invention, an outer-rotor-type single-phase brushless motor in which an outer member thereof is rotated as a rotor or an inner-rotor-type single-phase brushless motor in which an inner member thereof is rotated as a rotor can be provided.

### BRIEF DESCRIPTION OF DRAWINGS

FIG. 1 is a cross-sectional view showing an inner structure of a single-phase brushless motor around an axial direction in accordance with an embodiment of the present invention.

FIG. 2 is a cross-sectional view showing relationships between parameters in an embodiment.

FIG. 3 is a conceptual diagram showing a condition of a density distribution of a surface magnetic flux of a rotor permanent magnet.

FIG. 4 is a partially enlarged cross-sectional view showing an inner structure in FIG. 1.

FIG. 5 is a cross-sectional view showing an inner structure of a single-phase brushless motor around the axial direction of a modification of an embodiment.

FIG. 6 is a graph showing characteristics of an embodiment and a comparative example.

FIG. 7 is a graph sowing characteristics of an embodiment and the comparative example.

FIG. 8 is a cross-sectional view showing an inner structure of a single-phase brushless motor in which a groove is not provided thereto of the comparative example.

FIG. 9 is a cross-sectional view showing an inner structure of a single-phase brushless motor around the axial direction of another embodiment.

### DESCRIPTION OF PREFERRED EMBODIMENTS

### (1) First Embodiment

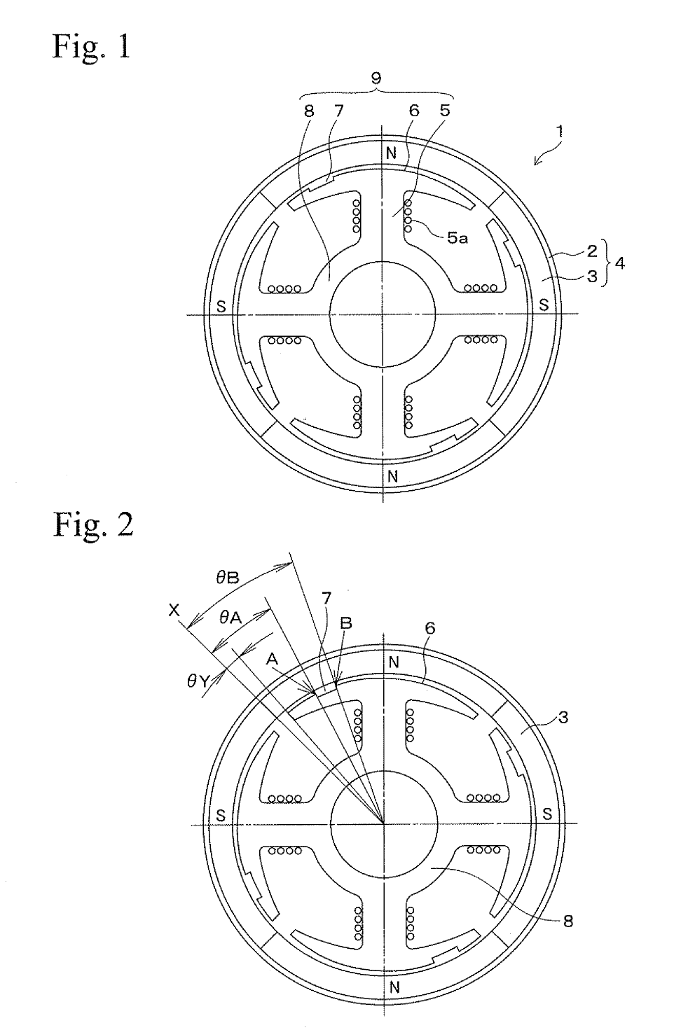

A cross-sectional structure of a single-phase brushless motor 1 around an axial direction of an embodiment is shown in FIG. 1. The single-phase brushless motor 1 is an outer-rotor-type single-phase brushless motor provided with four slots and four poles, in which an inner side member is a stator and an outer side member is rotated relative to the stator. The single-phase brushless motor 1 is provided with a stator 9 disposed at the inside thereof and a rotor 4 disposed at the outside of the stator 9 via a gap and rotating relative to the stator 9.

The stator 9 is provided with a stator iron-core 8. The stator iron-core 8 is provided with four salient poles 5 extending in a radially outward direction. A stator coil 5a functioning as a driving coil is wound around each salient pole 5. The radial outer portion of the salient pole 5 is extended toward a circumferential direction in a bevel shape, whereby a salient pole surface 6 is provided at an outer circumference of the salient pole 5 and is facing an inner circumference of the rotor 4 via the gap. A groove 7 as a radial recessed portion is provided at a portion apart from the circumferential center (a portion in the vicinity of the circumferential end) of the salient pole surface 6 that is the outer portion having an expanded bevel structure in side view thereof. In this example, the groove 7 is axially extended across the full width of the salient pole surface 6.

The rotor 4 has a structure in which a rotor permanent magnet 3 is contained set in the inside of a rotor yoke 2 having a cylindrical shape. As shown in figures, the rotor permanent magnet 3 is magnetized in a condition in which four magnetic poles are formed.

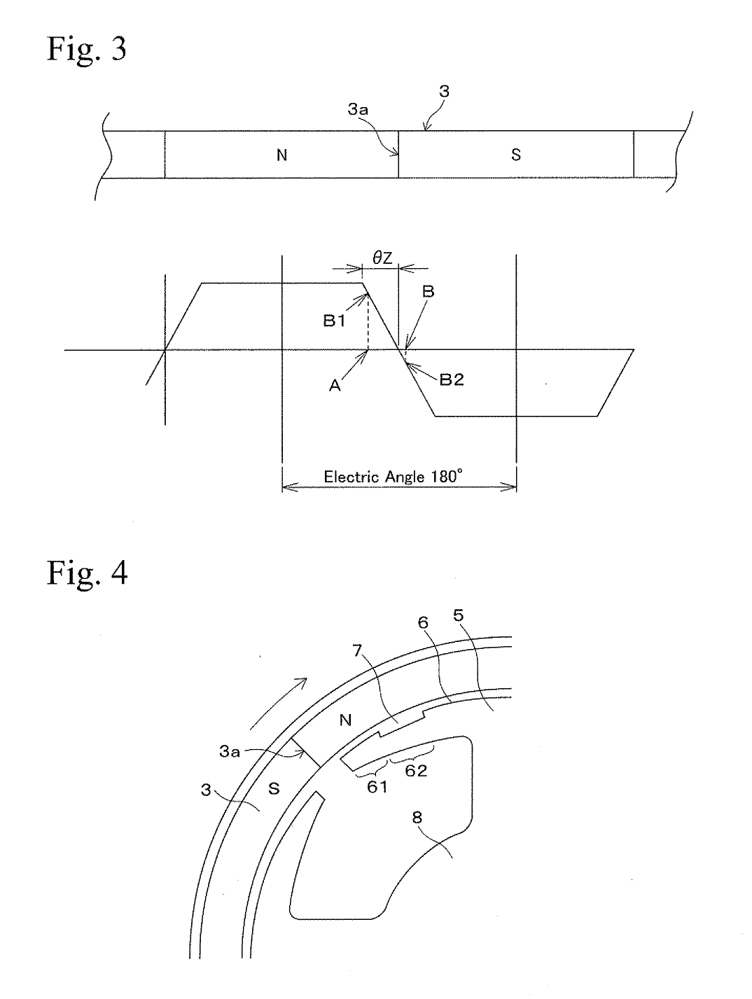

The groove 7 is provided at each of four salient pole surfaces 6. A position of the groove 7 is explained hereinafter. FIG. 2 is a conceptual diagram showing relationships between parameters for positioning the groove 7. FIG. 3 is a conceptual diagram showing a condition of a distribution of a surface magnetic flux density of the rotor permanent magnet 3 at an angular position and relationship between a point A and a point B shown in FIG. 2. FIG. 3 shows the rotor permanent magnet 3 in a condition in which a structure thereof is extended in a linear shape to facilitate understanding.

The groove 7 is provided at the position apart from the center in the circumferential direction (the position in the vicinity of the end) of the salient pole surface 6. As shown in FIG. 3, the rotor permanent magnet 3 is magnetized so that a distribution of a magnetic flux density along the circumferential direction has a shape including a plane portion and sloping portions positioned at both sides of the plane portion (a trapezoidal shape in FIG. 3).

In FIG. 2, reference symbol “X” is the center in the circumferential direction of an opening slot (the center in the circumferential direction of a gap between the adjacent salient poles 5). Reference symbol “θY” is an angular width having ½ of the angular width of the opening slot. That is, the opening slot has an angular width two times the angular width of “θY”. In this case, reference symbol “θA” is an angular width from “X” to an angular position A of the groove 7. The angular position A is that of an end portion of the groove 7 in the vicinity of an end of the salient pole surface 6 having an expanded bevel structure in the circumferential direction. Reference symbol “θB” is an angular width from “X” to an angular position B of the groove 7. In this case, the angular position B is that of an end portion of the groove 7 in the vicinity of the center of the salient pole surface 6 having an expanded bevel structure in the circumferential direction. As shown in FIG. 3, an angular width of the sloping portion of the wave shape at both ends of the magnetic pole of the rotor permanent magnet 3 is “θZ”.

In this case, (1) the groove 7 is disposed at the position apart from the center in the circumferential direction of the salient pole surface 6 and (2) the structure of the groove 7 satisfies the formula θA≧θY+θZ. These conditions are explained hereinafter.

Cogging torque is caused by unevenness of rotational torque and is caused when the polarity of the magnetic pole is not smoothly switched in relative moving of the salient pole and the magnet facing thereto. Therefore, the cogging torque occurs in a condition in which the end portion of the salient pole having the expanded bevel structure is positioned in the vicinity of a boundary between the magnetic poles. In the embodiment shown in Figures, balance of magnetic force acting on both sides of the groove 7 is adjusted by providing the groove 7 at the salient pole surface 6, so that the peak value of the cogging torque is reduced by generating torque to cancel the cogging torque.

The above condition is specifically explained hereinafter. FIG. 4 shows a condition in which the rotor permanent magnet 3 is rotating toward the clockwise direction in FIG. 4 relative to the stator iron-core 8. A condition in which a magnetic pole boundary 3a of the rotor permanent magnet 3 is positioned in the vicinity of the end portion of the salient pole surface 6 is shown in FIG. 4. In this case, a gap formed between the groove 7 and the rotor permanent magnet 3 is enlarged compared to surrounding gaps, so that magnetic flux density in the gap on the groove 7 is reduced compared to the magnetic flux density in the gap on the portion of the salient pole surface 6 other than the groove 7. That is, the magnetic flux density acting at a portion of reference symbol “62” is relatively lower compared to the magnetic flux density acting at a portion indicated by reference symbol “61”. The torque for reducing the peak value of the cogging torque is generated due to difference in these densities of magnetic fluxes.

That is, in the model shown in FIG. 4, the groove 7 is provided, so that the torque (the torque toward the direction opposite to that of the cogging torque) for canceling the rotating torque by which the rotor permanent magnet 3 is strongly rotated toward the right-hand direction compared to the perfect condition is generated. Therefore, the peak value of the cogging torque can be reduced.

In a condition in which the rotor permanent magnet 3 is further rotated and a formula |θA−θB|≦θZ (that is, the absolute value of θA−θB is less than or equal to θZ) is satisfied, as shown in FIG. 3, a size of the magnetic flux density acting on the outer end portion A of the groove 7 is larger than that of the magnetic flux density acting on the inner end portion B. This torque generated due to difference in the sizes of the magnetic flux density acts to reduce the peak value of the cogging torque. When the rotor 4 is further rotated from the condition shown in FIG. 3, relationship in which the magnitude of the magnetic flux density acting on the outer end portion A of the groove 7 is larger than that of the magnetic flux acting on the inner end portion B thereof is reversed. In this condition of the reversed relationship, an acute increase in the peak value of the cogging torque does not occur any longer, so that the groove 7 does not effect to reduce the cogging torque but the cogging torque having the reduced peak value caused by providing the groove 7 occurs.

In the present embodiment, the rotor permanent magnet 3 is magnetized in a condition in which a plane portion and sloping portions at both sides of the plane portion shown in FIG. 3 are formed in the wave shape of distribution of the magnetic flux. This sloping portion is a transition range in which polarity of the magnetic pole is switched. In a case in which the rotor permanent magnet 3 is magnetized in this condition, the effect of switching the polarity of the magnet pole occurs when the end portion of the salient pole surface 6 is approached to a position of the sloping range of the wave shape. Therefore, if the groove 7 is not positioned at a location apart from the center in the circumferential direction (that is, the position in the vicinity of the end) of the salient pole surface 6, the explained function for reducing the cogging torque is not effectively obtained.

The distribution of the magnetic flux which causes the cogging torque affects the position in the vicinity of the center in the circumferential direction of the salient pole surface 6 as the sloping is gentle of the portion. Therefore, in this case, the grove 7 is effectively provided at the position in the vicinity of the center of the salient pole surface 6. On the other hand, when the sloping portion is sharp, the groove 7 is effectively provided at the position in the vicinity of the end of the salient pole surface 6. This positioning is quantitatively determined by a condition limited by the formula θA≧θY+θZ. According to this condition, when a value of “θZ” is relatively small (that is, the sloping portion is sharp), the end portion of the groove 7 (the point A) is preferably positioned in the vicinity of the end of the salient pole surface 6. When the value of “θZ” is relatively large (that is, the sloping portion is gentle), the end portion of the groove 7 (the point A) is apart from the end of the salient pole surface 6 and is preferably positioned in the vicinity of the center thereof.

### (2) Second Embodiment

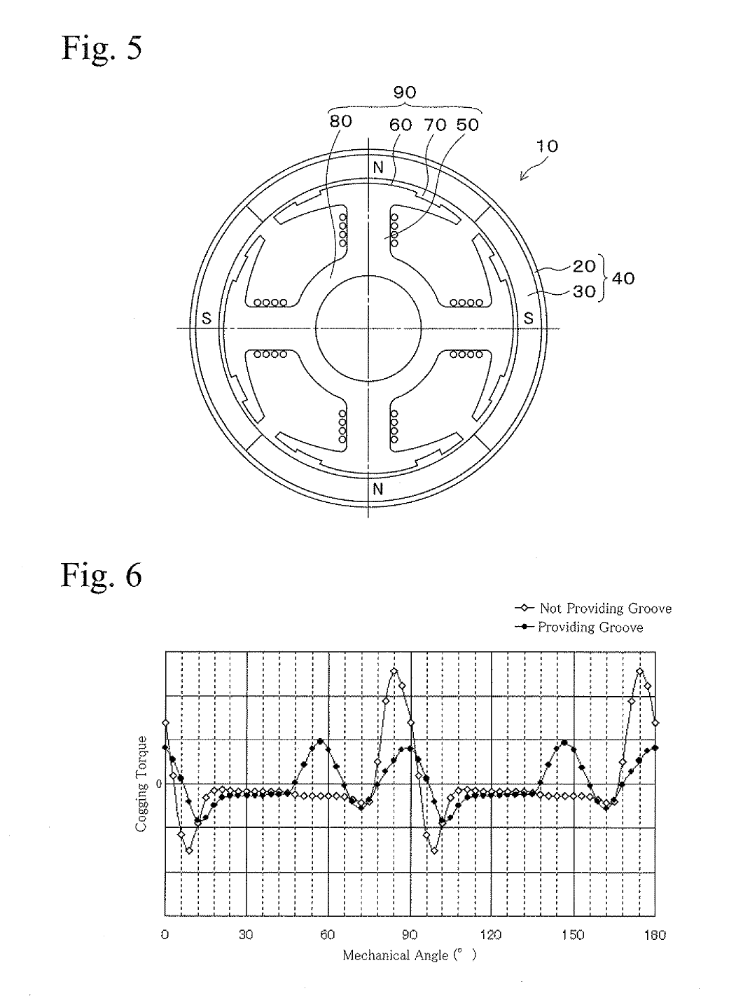

An example of a modification of the present embodiment is shown in FIG. 5. A single-phase brushless motor 10 is shown in FIG. 5. The single-phase brushless motor 10 is provided with a rotor 40 composed of a rotor yoke 20 and a rotor permanent magnet 30. The rotor 40 has the same structure as that of the first embodiment. A stator 90 is disposed in the inside of the rotor permanent magnet 30. The stator 90 is provided with a stator iron-core 80 and the stator iron-core 80 is provided with four salient poles 50. Each salient pole 50 is provided with a salient pole surface 60. This explained structure is the same as that of the first embodiment.

Difference in the structure from that of the first embodiment is explained hereinafter. The salient pole surface 60 is provided with two grooves 70. When the salient pole surface 60 is provided with one groove 70, this structure is the same as that of the first embodiment. Two grooves 70 are formed at symmetric positions about the center of the salient pole surface 60 and have symmetric structures.

As described later, the groove 70 formed at a position in the vicinity of the end of the salient pole surface 60 act to reduce the peak value of the cogging torque at a positive side or a negative side. Therefore, both the positive and negative cogging torques can be reduced by providing the grooves 70 at the right-hand position and the left-hand position of the salient pole surface 60.

### (3) Tests

A test result of advantages of the present invention obtained by simulation is explained hereinafter. In this test, a sample having the same structure as that of the single-phase brushless motor 1 of the present embodiment shown in FIG. 1, which satisfies the condition limited by formula θA=θY+θZ and the comparative example shown in FIG. 8 were prepared. A singe-phase brushless motor 100 of the comparative example is shown in FIG. 8. The singe-phase brushless motor 100 shown in FIG. 8 has the same structure as that of the singe-phase brushless motor 1 shown in FIG. 1 except for the point in which the groove is not provided at the salient pole surface.

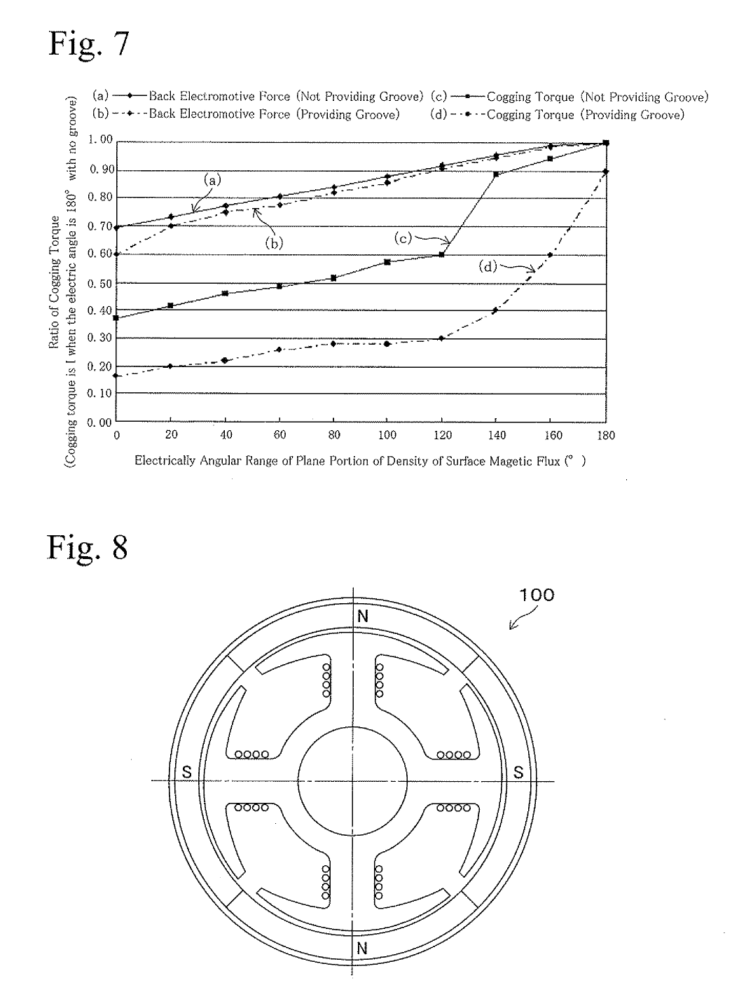

Relationships between angular widths of the rotor (applied on the horizontal axis) and the occurring cogging torques (applied on the vertical axis) are shown in FIG. 6. In FIG. 6, the description “not providing groove” indicates the singe-phase brushless motor 100 shown in FIG. 8 and the description “providing groove” indicates the sample having the same structure as that of the single-phase brushless motor 1 of the embodiment in FIG. 1, which satisfies a condition limited by the formula θA=θY+θZ. These indications are also applied in FIG. 7 described later. As shown in FIG. 6, the peak value of the cogging torque can be reduced by providing the groove 7 as shown in FIG. 1.

In FIG. 7, the electrically angular ranges in the plane portion of the surface magnetic flux density of the rotor permanent magnet 3 are applied on the horizontal axis. Furthermore, when the ratio of the cogging torque in a condition in which the groove is not provided and the electrically angular range is set at 180° (the shape of the magnetizing wave is rectangular) is determined to be 1, the ratios of the cogging torques are applied on the vertical axis in FIG. 7. That is, in the horizontal axis in FIG. 7, the electric angular widths showing the ratios of the plane portion from the magnetizing in a sine-curved shape in which the plane portion of the surface magnetic flux density is not formed to the magnetizing in the rectangular-waving shape in which the plane portion thereof is formed at a ratio of 100% is applied thereon.

According to FIG. 7, even if the groove is provided, degradation of back-electromotive force required in starting the motor can be reduced compared to the case in which the groove is not provided. Furthermore, the cogging torque can be greatly reduced by providing the groove. That is, according to FIG. 7, when the groove is provided, the cogging torque can be reduced without causing start-up instability compared to the case in which the groove is not provided. Vibration in operation can be reduced by reducing the cogging torque, so that a quiet motor can be obtained.

### Modifications of the Embodiment

In FIG. 6, the peak value in the positive side of the cogging torque can be greatly reduced by providing the groove 7. According to this condition, one groove provided at the position in the vicinity of the end of the salient pole surface has the function of reducing the cogging torque in the positive side or the negative side. This is demonstrated in the simulation testing. Therefore, as shown in FIG. 5, the peak values of the cogging torques in both positive and negative sides can be reduced by providing the grooves 7 at both sides of the center of the salient pole surface.

Therefore, when the cogging torque of the structure not provided with the groove is measured and the peak value of the cogging torque prominently occurs at only one of the positive side and the negative side, the groove may be formed at only one of the right-hand portion or the left-hand portion of the salient pole surface so as to reduce the peak value thereof. By this structure, characteristics in which the peak value in the positive side and the negative side of the cogging torque is reduced can be eventually obtained. Furthermore, when the condition of the cogging torque is unbalanced in measuring the value of the cogging torque of the structure in which the groove is not provided thereto, the structure of the grooves shown in FIG. 5 are formed in unbalanced shapes according to the unbalance of the condition, and therefore the structure for reducing the unbalanced peak value at the positive side or the negative side of the cogging torque can also be applied.

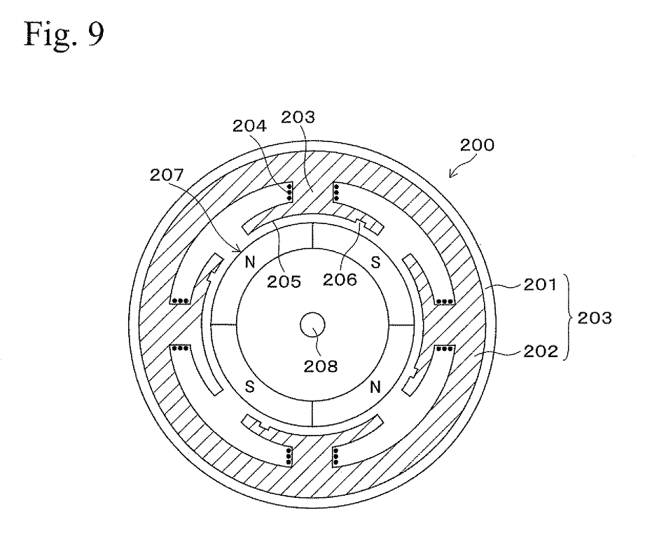

The present invention can be applied to an inner-rotor-type single-phase brushless motor. One example of the inner-rotor-type single-phase brushless motor is shown in FIG. 9. A single-phase brushless motor 200 is shown in FIG. 9. The single-phase brushless motor 200 is provided with a stator 203. The stator 203 is provided with a stator yoke 201 and a stator iron-core 202. The stator iron-core 202 is provided with four salient poles 203 extending toward a center of a rotor 207. A stator coil 204 is wound around the salient poles 203. An end portion of the salient pole has an expanded bevel shape, whereby a salient pole surface 205 is facing the outer circumference of the rotor 207 described later. A groove 206 is provided at the position apart from the center of the salient pole surface 205. The rotor 207 is disposed at the inside of four salient pole surfaces 205 via gaps. The outer circumference of the rotor 207 is magnetized in a condition in which four poles are formed. A rotational shaft 208 is secured at the center of the rotor 207 and the rotor 207 is rotates relative to the stator 203.

In this case, the magnetic pole of the rotor 207 is magnetized in a condition in which the distribution of the surface magnetic flux density has the plane portion and the sloping portions formed at both sides of the plane portion shown in FIG. 3. Furthermore, the groove 206 has a structure satisfying the same condition as those of the first embodiment.

The present invention is not limited to each explained embodiment and includes modifications that will be obvious to those skilled in the art, and the effects of the invention are not restricted to those of the above embodiments. That is, various additions, modifications, and partial omissions are possible within the scope of the concept of the invention and the objects of the invention, as claimed, and equivalents thereof.

The present invention can be applied to a single-phase brushless motor.

What is claimed is:

1. A single-phase brushless motor comprising:
a rotor including a plurality of magnetic poles;
a stator disposed facing the rotor via a gap and including the same number of salient poles as that of the magnetic poles;
a driving coil wound around the a plurality of salient poles;
a salient pole surface having a bevel-shape and provided on each salient pole, the salient pole surface facing the rotor
a groove provided at a position between a center and an end in a circumferential direction of each salient pole surface;
wherein a wave shape of each surface magnetic flux density of the plurality of magnetic poles has a distribution of the surface magnetic flux density composed of sloping portions disposed at both sides of the wave shape and a plane portion disposed between the sloping portions.

2. A single-phase brushless motor according to claim 1, wherein the groove is formed at both sides of the center on each salient pole surface in the circumferential direction.

3. A single-phase brushless motor according to claim 1, wherein an angular width between a center position of the adjacent salient poles in the circumferential direction and an end of the groove in a direction toward an end portion of the salient pole surface around a rotational center is defined as θA, an angular width between the ends of the adjacent salient pole in the circumferential direction around the rotational center is defined as 2θY, an angular width between both ends of the sloping portion of the wave shape of the magnetic pole of the rotor around the rotational center is defined as θZ, and a formula θA≧θY+θZ is satisfied.

4. A single-phase brushless motor according to claim 2, wherein an angular width between a center position of the adjacent salient poles in the circumferential direction and an end of the groove in a direction toward an end portion of the salient pole surface around a rotational center is defined as θA, an angular width between the ends of the adjacent salient pole in the circumferential direction around the rotational center is defined as 2θY, an angular width between both ends of the sloping portion of the wave shape of the magnetic pole of the rotor around the rotational center is defined as θZ, and a formula θA≧θY+θZ is satisfied.

5. A single-phase brushless motor according to claim 1, wherein one of a positive peak value and a negative peak value of a cogging torque occurring in a case not provided with the groove can be reduced by providing the groove at a position between the center and the end in the circumferential direction of the salient pole surface.

6. A single-phase brushless motor according to claim 2, wherein one of a positive peak value and a negative peak value of a cogging torque occurring in a case not provided with the groove can be reduced by providing the groove at a position between the center and the end in the circumferential direction of the salient pole surface.

7. A single-phase brushless motor according to claim 3, wherein one of a positive peak value and a negative peak value of a cogging torque occurring in a case not provided with the groove can be reduced by providing the groove at a position between the center and the end in the circumferential direction of the salient pole surface.

8. A single-phase brushless motor according to claim 1, wherein an outer-rotor-type structure or an inner-rotor-type structure is applied.

9. A single-phase brushless motor according to claim 2, wherein an outer-rotor-type structure or an inner-rotor-type structure is applied.

10. A single-phase brushless motor according to claim 3, wherein an outer-rotor-type structure or an inner-rotor-type structure is applied.

11. A single-phase brushless motor according to claim 4, wherein an outer-rotor-type structure or an inner-rotor-type structure is applied.
